(19) United States
(12) Patent Application Publication
(10) Pub. No.: US 2007/0298814 A1
(43) Pub. Date: Dec. 27, 2007

(54) Position recognition method and system

(75) Inventors: Wan-jin Kim, Yongin-si (KR); Min-seop Jeong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/640,276

(22) Filed: Dec. 18, 2006

(30) Foreign Application Priority Data
Jun. 14, 2006 (KR) 10-2006-0053289

(51) Int. Cl. H04Q 7/20

(52) U.S. Cl. 455/456.1

(57) ABSTRACT

A position recognition method and system include transmitting a first transmit signal and a second transmit signal via a first transmit antenna and a second transmit antenna of a transmitter at intervals; receiving the first transmit signal and the second transmit signal via an receive antenna of a receiver; and calculating a position of the receiver using transmission times of the first transmit signal and the second transmit signal. Accordingly, the mobile object can recognize its position efficiently.

### CROSS-REFERENCE TO RELATED APPLICATIONS

This application claims priority from Korean Patent Application No. 10-2006-0053289 filed on Jun. 14, 2006 in the Korean Intellectual Property Office, the disclosure of which is incorporated herein by reference.

### BACKGROUND OF THE INVENTION

1. Field of the Invention

Methods and systems consistent with the present invention relate to position recognition, and more particularly, to calculating a position by receiving a signal from a station so that a mobile object can recognize its position indoors.

2. Description of the Related Art

A related art method utilizes a position recognition system as shown in FIGS. 1A and 1B to acquire positions of objects indoors.

FIGS. 1A and 1B are diagrams of a construction of the related art recognition system.

In FIG. 1A, anchor nodes Rx1, Rx2, Rx3, and Rx4 aware of their position coordinates, a reference tag Tx_r aware of its position coordinates, and a tag Tx to acquire its position coordinates reside indoors.

The anchor nodes Rx1, Rx2, Rx3, and Rx4 receive a signal from the tag Tx and forward it to a processor (not shown). The processor calculates the position of the tag Tx using the time difference of the arrived signals from the anchor nodes Rx1, Rx2, Rx3, and Rx4. Likewise, the anchor nodes Rx1, Rx2, Rx3, and Rx4 receive a signal from the reference tag Tx_r and forward it to the processor. The processor corrects the position error of the tag Tx using the signal of the reference tag Tx_r which is aware of its position coordinates.

FIG. 1B is a partial block diagram of the related art position recognition system of FIG. 1A. The related art position recognition system includes a transmitter 10, a first receiver 22, a second receiver 24, and a processor 25.

The transmitter 10 corresponds to the tag Tx of which the position coordinates is to be acquired. The transmitter 10 transmits radio frequency (RF) signals via an antenna 15.

The first receiver 22 corresponds to one of the anchor nodes Rx1, Rx2, Rx3, and Rx4 aware of its coordinates. The first receives signals from the transmitter 10 via a first receive antenna 21 and forwards the received signals to the processor 25.

The second receiver 24 corresponds to one of the anchor nodes Rx1, Rx2, Rx3, and Rx4 aware of its coordinates. The second receiver 24 receives signals from the transmitter 10 via a second receive antenna 23 and forwards the received signals to the processor 25.

Upon receiving the signals of the first receiver 22 and the second receiver 24, the processor 25 calculates the position of the transmitter 10 using time difference of arrival (TDOA). In detail, the position of the transmitter 10 is calculated using the TDOA of the signals received from the first receiver 22 and the second receiver 24.

Disadvantageously, the position recognition system of FIGS. 1A and 1B needs to arrange the anchor nodes Rx1, Rx2, Rx3, and Rx4 at accurate positions. If the positions of the first receiver 22 and the second receiver 24 are not accurate, it is impossible to calculate an accurate position of the transmitter 10. As the number of the receivers 22 and 24 increases, the number of chains to forward the signals from the receivers 22 and 24 to the processor 25 also increases. Thus, the system setup becomes complicated. As a result, such a related art position recognition system is not suitable for the position recognition of the mobile object such as robot vacuum cleaner.

For the position recognition of the mobile object, a position recognition system of FIG. 2 is mostly employed to simplify the system setup, in which an anchor node Rx is embedded in a station.

FIG. 2 is a block diagram of another related art position recognition system.

Referring to FIG. 2, the position recognition system for acquiring the position of a mobile object includes a transmitter 10 and a receiver 30.

The transmitter 10, corresponding to a mobile object such as robot cleaner, transmits RF signals via an antenna 15.

The receiver 30, corresponding to a charge station for charging the robot cleaner, receives signals from the transmitter 10 via a first receive antenna 31 and a second receive antenna 33. The receiver 30 includes a delayer 35, a receiving part 37, and a processor 39.

The delayer 35 delays the signal received to the second receive antenna 3 and provides the delayed signal to the receiving part 37. The receiving part 37 sequentially forwards the signal received via the first receive antenna 31 and the delayed signal from the delayer 35 to the processor 39.

Upon receiving the signals from the receiving part 37, the processor 39 calculates the position of the transmitter 10 using the TDOA. That is, the position of the transmitter 10 is calculated using the time difference of the arrived signals of the reception part 37.

In the position recognition system of FIG. 2, the system installation is facilitated since the anchor node Rx is embedded in the receiver 30, and the number of the chains is minimized by virtue of the delayer 35. However, increasing the number of the mobile objects to acquire their position coordinates increases the number of signals transmitted from the mobile objects. Thus, interference occurs between the signals transmitted from the mobile objects, and the accurate positions of the mobile objects are not acquired.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a position recognition method and system which calculates an accurate position of a mobile object by avoiding signal interference even when the number of mobile objects increases.

The present invention also provides a position recognition method and system which recognizes a position of a mobile object by embedding an anchor node, which is a coordinate reference, into a station so as to simplify a system setup.

The present invention also provides a position recognition method and system which enables a mobile object to acquire its position by embedding a receiver into the mobile object so as to realize an unattended active mobile object.

According to an aspect of the present invention, a position recognition method includes transmitting a first transmit (Tx) signal and a second Tx signal via a first Tx antenna and a second Tx antenna of a transmitter at intervals; receiving the first Tx signal and the second Tx signal via a receive (Rx) antenna of a receiver; and calculating a position of the receiver using transmission times of the first Tx signal and the second Tx signal.

The transmitting operation may include generating the first Tx signal based on first digital data; transmitting the first Tx signal via the first Tx antenna; waiting for the time interval; generating the second Tx signal based on second digital data; and transmitting the second Tx signal via the second Tx antenna.

The receiving operation may include calculating a distance between the Rx antenna and the first Tx antenna by synchronizing the first Tx signal; calculating a distance between the Rx antenna and the second Tx antenna by synchronizing the second Tx signal; and calculating the position of the receiver using the distance between the Rx antenna and the first Tx antenna and the distance between the Rx antenna and the second Tx antenna.

According to an aspect of the present invention, a transmitter includes a plurality of Tx antennas which transmit signals; and a Tx part which provides a plurality of Tx signals to the plurality of the Tx antennas at intervals.

The plurality of the Tx antennas may be spaced a distance apart from each other at intervals.

The transmitter may further include a selection part which selects one of the Tx antennas; and a control part which controls the selection part to select one of the Tx antennas and transmits the Tx signal corresponding to the selected antenna at intervals.

According to an aspect of the present invention, a receiver includes at least one Rx antenna which receives signals from a plurality of Tx antennas; and a control part which calculates a distance between the Rx antenna and one of the Tx antennas by synchronizing the signal received via the Rx antenna.

The receiver may further include an Rx part which demodulates the signal received via the Rx antenna to digital data.

The control part may calculate a position of the receiver using distances between the Rx antenna and the Tx antennas.

The control part may calculate the distance between the Rx antenna and the one of the Tx antennas using transmission times taken for signals emitted from the Tx antennas to arrive at the Rx antenna.

According to an aspect of the present invention, a position recognition system includes a transmitter which transmits a first Tx signal and a second Tx signal via a first Tx antenna and a second Tx antenna at intervals; and a receiver which receives the first Tx signal and the second Tx signal via an Rx antenna and calculates a position of the receiver using the first Tx signal and the second Tx signal.

The receiver may calculate the position of the receiver using a transmission time taken for the first Tx signal emitted from the first Tx antenna to arrive at the Rx antenna and a transmission time taken for the second Tx signal emitted from the second Tx antenna to arrive at the Rx antenna.

The receiver may calculate the position of the receiver by calculating a distance between the Rx antenna and the first Tx antenna and a distance between the Rx antenna and the second Tx antenna.

The receiver may calculate a distance and an angle to the transmitter using the first Tx signal and the second Tx signal.

### BRIEF DESCRIPTION OF THE DRAWING FIGURES

The above and other aspects of the present invention will become more apparent and more readily appreciated from the following description of exemplary embodiments thereof, with reference to the accompanying drawings, in which:

FIGS. 1A and 1B are diagrams of a related art position recognition system;

FIG. 2 is a block diagram of another related art position recognition system;

FIG. 3 is a simplified block diagram of a position recognition system according to an exemplary embodiment of the present invention;

FIG. 4 is a simplified block diagram of a transmitter in the position recognition system according to an exemplary embodiment of the present invention;

FIG. 5 is a simplified block diagram of a receiver in the position recognition system according to an exemplary embodiment of the present invention;

FIG. 6 is a diagram of a signal format transmitted from the transmitter of the position recognition system according to an exemplary embodiment of the present invention;

FIGS. 7A and 7B are diagrams illustrating a position recognition method of the position recognition system according to an exemplary embodiment of the present invention;

FIG. 8 is a diagram illustrating the position recognition method with respect to a plurality of mobile objects using the position recognition system according to an exemplary embodiment of the present invention;

FIG. 9 is a flowchart outlining an operation of the transmitter in the position recognition method according to an exemplary embodiment of the present invention; and

FIG. 10 is a flowchart outlining an operation of the receiver in the position recognition method according to an exemplary embodiment of the present invention.

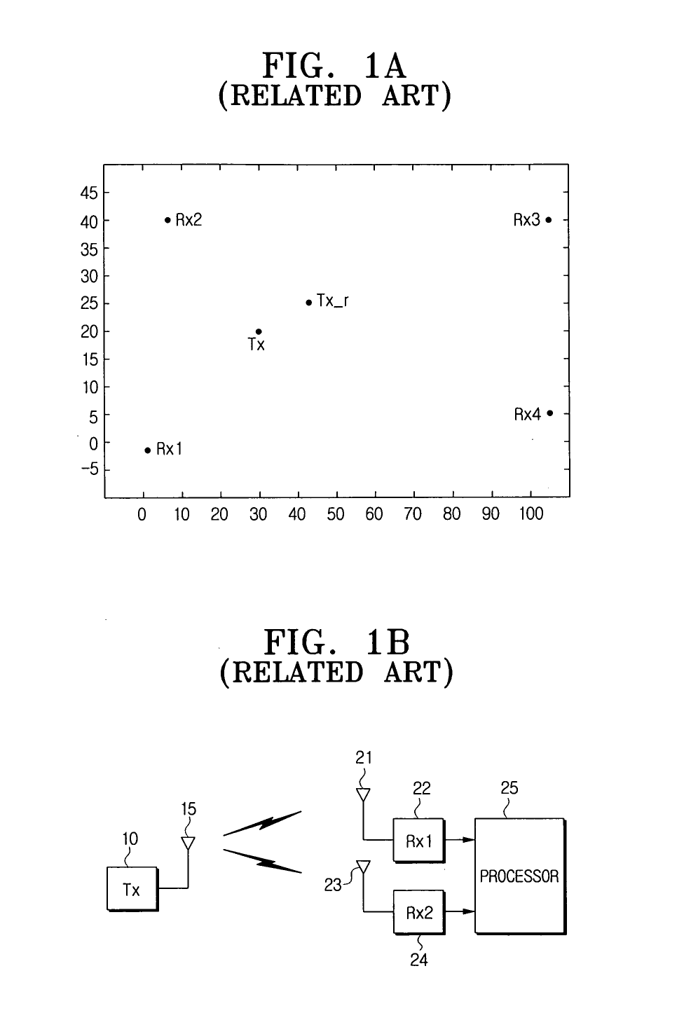

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known fuctions or constructions are not described in detail, since they would obscure the invention in unnecessary detail.

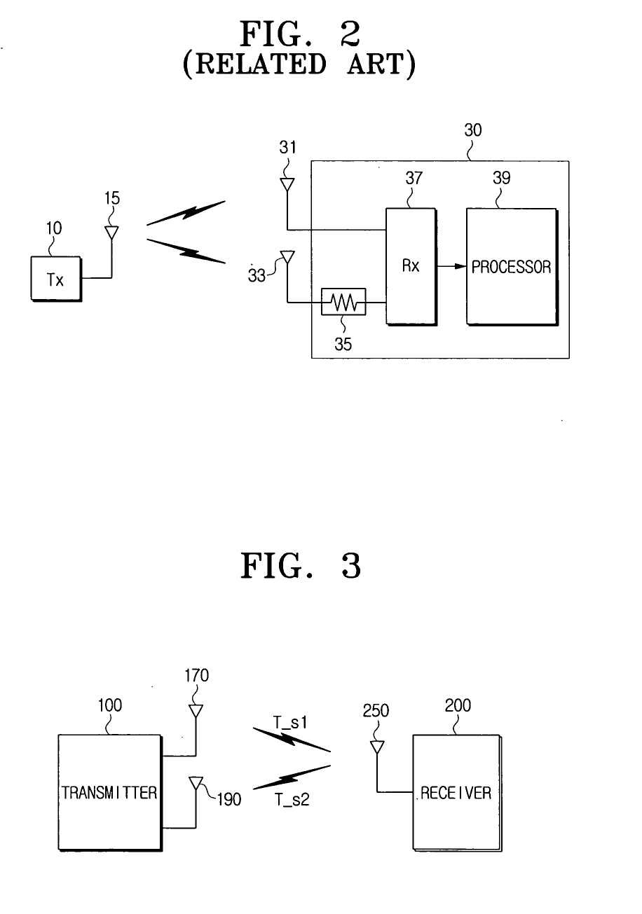

FIG. 3 is a simplified block diagram of a position recognition system according to an exemplary embodiment of the present invention. Although FIG. 3 illustrates the position recognition system which is primarily used to recognize the position of an unattended mobile object such as robot cleaner, it may be used to acquire the position of an object other than the unattended mobile object.

Referring now to FIG. 3, the position recognition system includes a transmitter 100 corresponding to a charge station for charging the robot cleaner, and a receiver 200 corresponding to the robot cleaner.

The transmitter 100 sends a first Tx signal T_s1 via a first Tx antenna 170 and a second Tx signal T_s2 via a second Tx antenna 190. The transmitter 100 sends the first Tx signal T_s1 and the second Tx signal T_s2 at time intervals via the first Tx antenna 170 and the second Tx antenna 190, respectively. The first Tx antenna 170 and the second Tx antenna 190 are spaced apart from each other.

The receiver 200 receives the first Tx signal T_s1 and the second Tx signal T_s2 via an Rx antenna 250. Next, the receiver 200 calculates a distance between the first Tx antenna 170 and the Rx antenna 250 using the transmission time taken for the first Tx signal T_s1 from the first Tx antenna 170 to arrive at the Rx antenna 250. Likewise, the receiver 200 calculates a distance between the second Tx antenna 190 and the Rx antenna 250 using the transmission time take for the second Tx signal T_s2 from the second Tx antenna 190 to arrive at the Rx antenna 250. The receiver 200 calculates its position using the distance between the first Tx antenna 170 and the Rx antenna 250 and the distance between the second Tx antenna 190 and the Rx antenna 250.

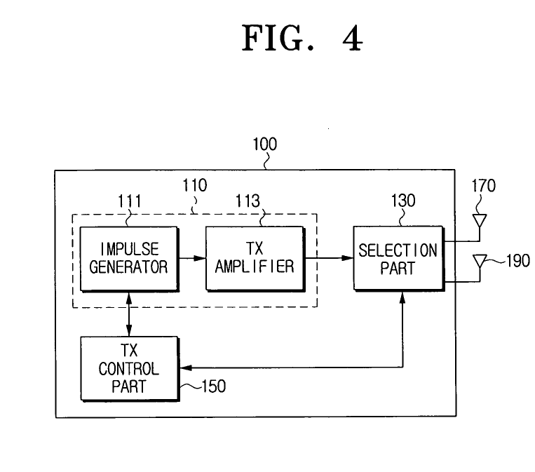

FIG. 4 is a simplified block diagram of the transmitter 100 in the position recognition system according to an exemplary embodiment of the present invention.

Referring to FIG. 4, the transmitter 100 includes a Tx part 110, a selection part 130, a Tx control part 150, the first Tx antenna 170, and the second Tx antenna 190.

The Tx part 110 generates the first Tx signal or the second Tx signal to transmit it via the first Tx antenna 170 or the second Tx antenna 190 under control of the Tx control part 150, which will be further explained. The Tx part 110 includes an impulse generator 111 and a Tx amplifier 113. The impulse generator 111 receives timing information from the Tx control part 150 and generates an analog impulse. The Tx amplifier 113 outputs the first or second Tx signal by amplifying the analog impulse.

The selection part 130 selects either the first Tx antenna 170 or the second Tx antenna 190 under the control of the Tx control part 150. The selection part 130 forwards the Tx signal generated at the Tx part 110 to the selected Tx antenna 170 or 190. The first Tx antenna 170 transmits the first Tx signal and the second Tx antenna 190 transmits the second Tx signal.

After generating first digital data corresponding to the timing information, the Tx control part 150 controls the selection part 130 to select the first Tx antenna 170 and controls the Tx part 110 to generate the first Tx signal. Hence, the first Tx signal is transmitted via the first Tx antenna 170. After a certain time period, the Tx control part 150 generates second digital data corresponding to the timing information, controls the selection part 130 to select the second Tx antenna 190, and controls the Tx part 110 to generate the second Tx signal. Thus, the second Tx signal is transmitted via the second Tx antenna 190.

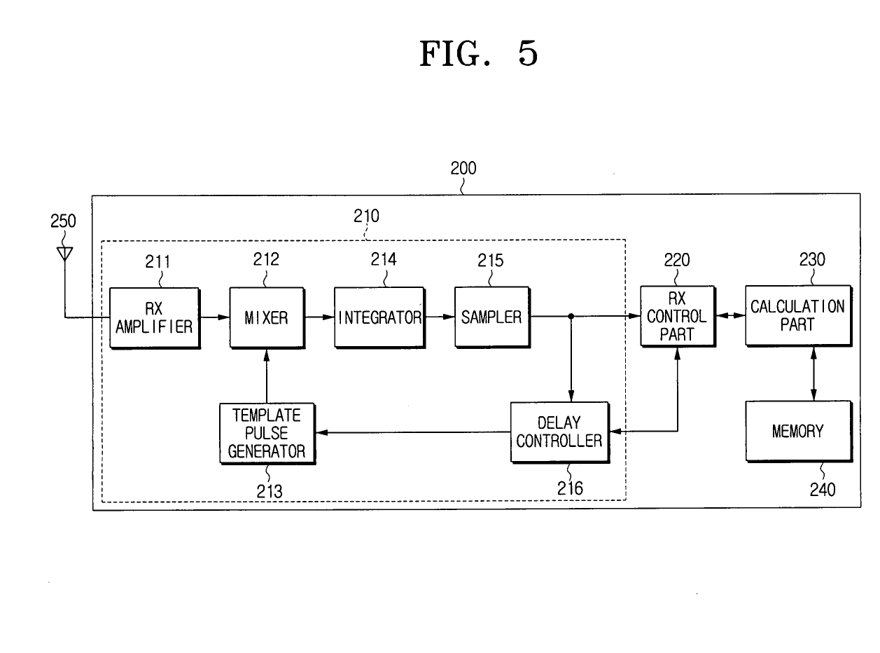

FIG. 5 is a simplified block diagram of the receiver 200 in the position recognition system according to an exemplary embodiment of the present invention.

Referring to FIG. 5, the receiver 200 includes an Rx part 210, an Rx control part 220, a calculation part 230, a memory 240, and the Rx antenna 250.

The Rx part 210 functions to generate digital data by synchronizing the signal received via the Rx antenna 250 and forwards the generated digital data to the Rx control part 220 which will be further explained. The Rx part 210 includes an Rx amplifier 211, a mixer 212, a template pulse generator 213, an integrator 214, a sampler 215, and a delay controller 216.

The Rx amplifier 211, which is a low noise amplifier (LNA), amplifies the level of the Tx signal attenuated in the transmission and minimizes noise. The template pulse generator 213 generates a template pulse which is the same signal as the receive signal, and forwards it to the mixer 212. The mixer 212 outputs a signal with a minimized narrow-band interference by mixing the signal output from the Rx amplifier 211 with the template pulse. The integrator 214 integrates the signal mixed with the template pulse and outputs the integrated signal. The sampler 215 samples the integrated signal to ‘0’ or ‘1’ and outputs the integrated as digital data.

The delay controller 216 controls the template pulse generator 213 to receive a clock from the Rx control part 220, to be explained later, and to synchronize the template pulse to the signal received via the Rx antenna 250.

After receiving the digital data from the Rx part 210, the Rx control part 220 controls the calculation part 230 to calculate the distance to the transmitter 100 by checking identifier TxID and data of the Tx signal that are contained in the digital data. The Rx control part 220 stores the calculation result of the calculation part 230 to the memory 240.

The calculation part 230, under the control of the Rx control part 220, calculates the position of the receiver 200 by calculating the distance to the transmitter 100. In detail, the calculation part 230 acquires the distance between the first Tx antenna 170 and the Rx antenna 250 using the transmission time taken for the first Tx signal emitted from the first Tx antenna 170 to arrive at the Rx antenna 250, and the distance between the second Tx antenna 190 and the Rx antenna 250 using the transmission time taken for the second Tx signal emitted from the second Tx antenna 190 to arrive at the Rx antenna 250. With the two acquired distances, the calculation part 230 calculates the distance and the angle between the transmitter 100 and the receiver 200.

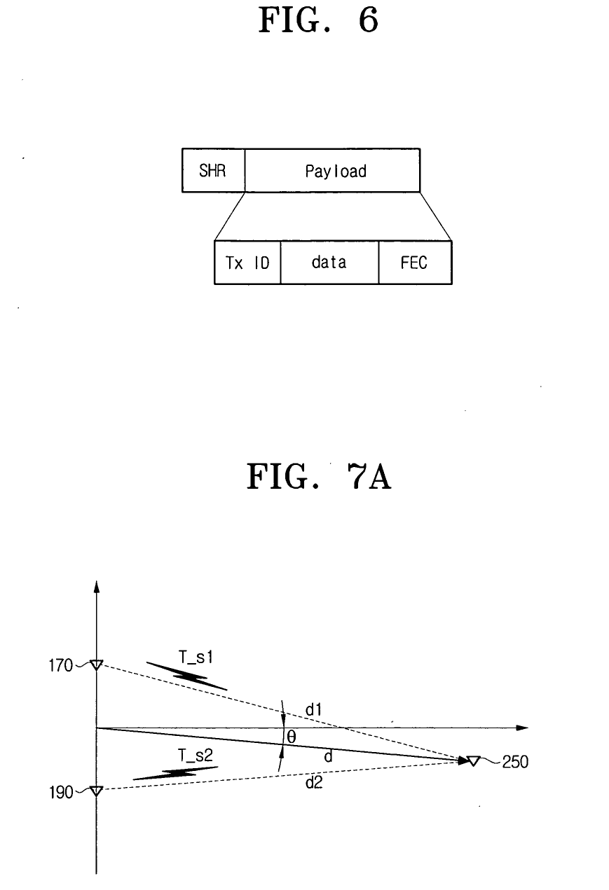

FIG. 6 is a diagram of a signal format transmitted from the transmitter 100 of the position recognition system according to an exemplary embodiment of the present invention.

The Tx signal of FIG. 6 consists of a synchronization header (SHR) and a payload. The payload consists of an identifier of the Tx signal TxID, data, and forward error correction (FEC) for correcting error of the Tx signal.

The Tx signal is modulated to an RF signal, infrared rays ultra wide band (IR UWB) signal, chirp signal, or chaotic signal and then transmitted from the transmitter 100 to the receiver 200.

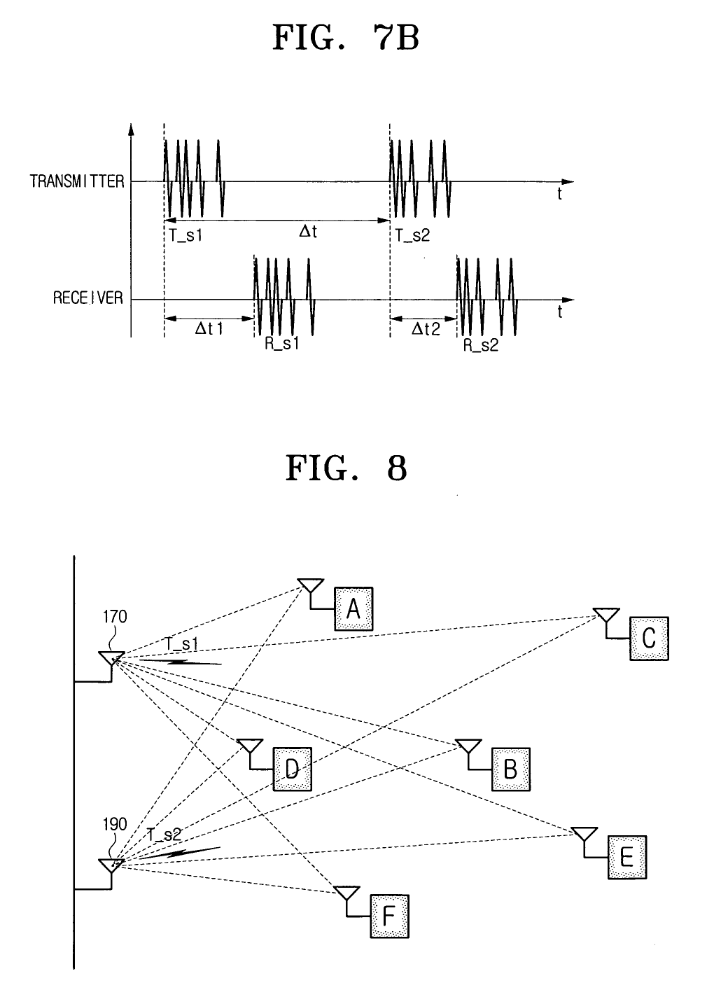

FIGS. 7A and 7B are diagrams illustrating a position recognition method of the position recognition system according to an exemplary embodiment of the present invention.

Referring to FIGS. 7A and 7B, the first Tx antenna 170 transmits the first Tx signal T_s1. After the time Δt, the second Tx antenna 190 transmits the second Tx signal T_s2. On the receiving side, the Rx antenna 250 receives the first Rx signal R_s1 after the time Δt1 from when the first Tx antenna 170 transmits the first Tx signal T_s1, and receives the second Rx signal R_s2 after the time Δt2 from when the second Tx antenna 190 transmits the second Tx signal T_s2.

The Rx control part 220 controls the calculation part 230 to calculate the distance d1 between the first Tx antenna 170 and the Rx antenna 250 and the distance d2 between the second Tx antenna 190 and the Rx antenna 250 using the transmission times Δt1 and Δt2. For the calculation of the distances d1 and d2, the speed of light (3*10⁸[m/sec]) is used. The Rx control part 220 controls the calculation part 230 to calculate the distance d and the angle θ between the transmitter 100 and the receiver 200 using the distances d1 and d2.

FIG. 8 is a diagram illustrating the position recognition method with respect to a plurality of mobile objects using the position recognition system according to an exemplary embodiment of the present invention.

Referring to FIG. 8, when the first Tx antenna 170 and the second Tx antenna 190, which are spaced apart from each other, emit the first Tx signal T_s1 and the second Tx signal T_s2, respectively, receivers A, B, C, D, E and F corresponding to the mobile objects receive the first Tx signal T_s1 and the second Tx signal T_s2. The receivers A, B, C, D, E and F calculate their locations by detecting transmission times Δt1 and Δt2 of the first Tx signal T_s1 and the second Tx signal T_s2 as described in reference to FIGS. 7A and 7B.

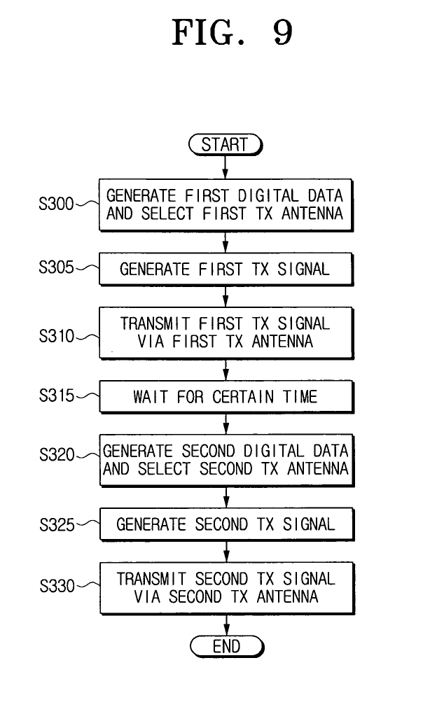

FIG. 9 is a flowchart outlining an operation of the transmitter 100 in the position recognition method according to an exemplary embodiment of the present invention.

Referring to FIG. 9, the Tx control part 150 generates first digital data and controls the selection part 130 to select the first Tx antenna 170 (S300). The Tx part 110 generates the first Tx signal according to the first digital data of the Tx control part 150 (S305). Next, the first Tx signal is transmitted via the first Tx antenna 170 (S310). The Tx control part 150 controls the transmitter 100 to wait for a certain time (S315).

After the certain time, the Tx control part 150 generates second digital data and controls the selection part 130 to select the second Tx antenna 190 (S320). The Tx part 110 generates the second Tx signal according to the second digital data of the Tx control part 150 (S325). The second Tx signal is transmitted via the second Tx antenna 190 (S330).

As such, the transmitter 100 sends the first Tx signal and the second Tx signal to the receiver 200 at intervals.

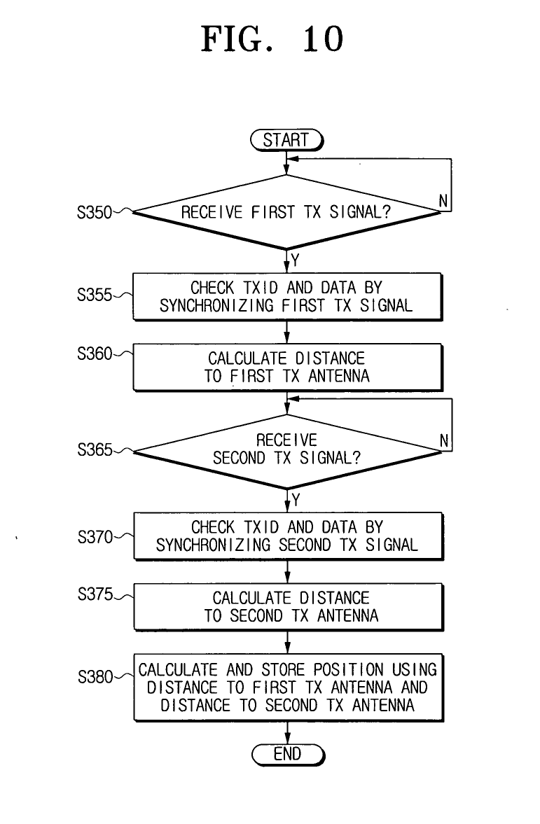

FIG. 10 is a flowchart outlining an operation of the receiver 200 in the position recognition method according to an exemplary embodiment of the present invention.

Referring to FIG. 10, upon receiving the first Tx signal via the Rx antenna 250 (S350), the Rx control part 220 checks the TxID and the data of the first Tx signal by synchronizing the first Tx signal (S355). Next, the Rx control part 220 controls the calculation part 230 to calculate the distance to the first Tx antenna 170 (S360).

After a certain time, upon receiving the second Tx signal (S365), the Rx control part 220 checks the TxID and the data of the second Tx signal by synchronizing the second Tx signal (S370). The Rx control part 220 controls the calculation part 230 to calculate the distance to the second Tx antenna (S375).

Finally, the Rx control part 220 controls the calculation part 230 to calculate the position of the receiver 200 using the distance to the first Tx antenna 170 and the distance to the second Tx antenna 190, and stores the calculation result in the memory 240 (S380).

As such, the receiver 200 can recognize its position by calculating the distance and the angle between the transmitter 100 and the receiver 200.

In light of the foregoing, since the mobile object receives the signals from the plurality of antennas embedded in the station, signal interference can be reduced even when the number of mobile objects to acquire their position coordinates increases. The position recognition system setup can be simplified by embedding the anchor node, which is the coordinate reference, into the station. Furthermore, the unattended active mobile operation is feasible because the mobile object is aware of its position.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A position recognition method, comprising:
transmitting a first transmit signal and a second transmit signal, at time intervals, via a first transmit antenna and a second transmit antenna of a transmitter;
receiving the first transmit signal and the second transmit signal via a receive antenna of a receiver; and
calculating a position of the receiver using transmission times of the first transmit signal and the second transmit signal.

2. The position recognition method of claim 1, wherein the transmitting comprises:
generating the first transmit signal based on first digital data;
transmitting the first transmit signal via the first transmit antenna;
waiting for the time interval;
generating the second transmit signal based on second digital data; and
transmitting the second transmit signal via the second transmit antenna.

3. The position recognition method of claim 1, wherein the receiving comprises:
calculating a distance between the receive antenna and the first transmit antenna by synchronizing the first transmit signal;
calculating a distance between the receive antenna and the second transmit antenna by synchronizing the second transmit signal; and
calculating the position of the receiver using the distance between the receive antenna and the first transmit antenna and the distance between the receive antenna and the second transmit antenna.

4. A transmitter comprising:
a plurality of transmit antennas which transmit signals; and
a transmitter part which provides a plurality of transmit signals, at time intervals, to the plurality of the transmit antennas.

5. The transmitter of claim 4, wherein the plurality of the transmit antennas is spaced a distance apart from each other.

6. The transmitter of claim 4, further comprising:
a selection part which selects one of the transmit antennas; and
a control part which controls the selection part to select one of the transmit antennas and transmit the transmit signal corresponding to the selected antenna at the time intervals.

7. A receiver comprising:
at least one receive antenna which receives signals from a plurality of transmit antennas; and
a control part which calculates a distance between the receive antenna and one of the transmit antennas by synchronizing the signals received via the receive antenna.

8. The receiver of claim 7, further comprising:
a receive part which demodulates the signals received via the receive antenna to digital data.

9. The receiver of claim 7, wherein the control part calculates a position of the receiver using distances between the receive antenna and the transmit antennas.

10. The receiver of claim 7, wherein the control part calculates the distance between the receive antenna and the one of the transmit antennas using transmission times taken for the signals emitted from the transmit antennas to arrive at the receive antenna.

11. A position recognition system comprising:
a transmitter which transmits a first transmit signal and a second transmit signal, at intervals, via a first transmit antenna and a second transmit antenna; and
a receiver which receives the first transmit signal and the second transmit signal via a receive antenna and calculates a position of the receiver using the first transmit signal and the second transmit signal.

12. The position recognition system of claim 11, wherein the receiver calculates the position of the receiver using a transmission time taken for the first transmit signal emitted from the first transmit antenna to arrive at the receive antenna and a transmission time taken for the second transmit signal emitted from the second transmit antenna to arrive at the receive antenna.

13. The position recognition system of claim 11, wherein the receiver calculates the position of the receiver by calculating a distance between the receive antenna and the first transmit antenna and a distance between the receive antenna and the second transmit antenna.

14. The position recognition system of claim 11, wherein the receiver calculates a distance and an angle to the transmitter using the first transmit signal and the second transmit signal.
